(19) United States
(12) Patent Application Publication
(10) Pub. No.: US 2008/0270512 A1
(43) Pub. Date: Oct. 30, 2008

(54) Virtual network projection system supporting multiple projection sources and method thereof

(75) Inventors: Xiaobing Guo, Beijing (CN); Dekui Zhang, Beijing (CN); Xiaoping Zhang, Beijing (CN); Xiaoyu Zhou, Beijing (CN); Shaowei Chen, Beijing (CN); Yiqiang Yan, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignees: Legend Holdings Ltd., Beijing (CN); Lenovo (Beijing) Limited, Beijing (CN)

(21) Appl. No.: 12/077,249

(22) Filed: Mar. 18, 2008

(30) Foreign Application Priority Data
Mar. 21, 2007 (CN) 200710064616.5

(51) Int. Cl. G06F 15/16

(52) U.S. Cl. 709/201

(57) ABSTRACT

A network projection system and method are disclosed, the system comprises announcement means for announcing virtual network projection device information over a network and receiving a projection request from at least one network projection source, projection data receiving means for receiving data used in projection from the at least one network projection source, processing means for processing the data received from the at least one network projection source to meet a user's requirement, and projection data displaying means for displaying the processed projection data on a connected display device or transmitting the processed projection data to another network projection device over the network. With the structure of the present invention, a common display device can be virtualized as a network projection device to facilitate simultaneous display of projection contents from multiple projection sources on the same screen or switching of display via the network.

### BACKGROUND OF THE INVENTION

1. Field of Invention

The present invention relates to network projection technology, in particular to a virtual network projection system supporting multiple projection sources and method thereof, which can present multiple projection screens on one or more clients.

2. Description of Prior Art

Projection devices have become an indispensable tool in our daily work and communications. As a problem commonly encountered, when a plurality of hosts need to project sequentially at a meeting, the connector to the projection device has to be repeatedly plugged and unplugged, which affects work efficiency adversely.

In view of the above problem, a network projection device has been proposed, which is a new one supported by Vista operating system. With the help of wireless technique, such projection device enables the screen of a computer connected to a network to be transmitted over the network to the projection device, so that no repeated plug and unplug is needed once the work of networking is finished. Unfortunately, such network projection device has some limit in application, that is, for the conventionally projection device having no support to network access, update is necessitated to add a network communication module for supporting the function of network access. With such update, a problem occurs that the projection device, which supports a simple network access, does not necessarily conform to the security protocol/specification of a corporation, which leads to certain security loophole. Further, such network projection device can currently receive the input of only one computer, in other words, it cannot switch between the projection contents from a number of projection hosts or display the contents at the same time.

Therefore, it is desirable to develop a technique which can support multiple projection sources and display the projection contents from the sources on the same screen or switch between multiple screens.

### SUMMARY OF THE INVENTION

The present invention is made to address the above problems. The object of the present invention is to provide a virtual network projection system supporting multiple projection sources and a method thereof, which can have the multiple projection sources accessed simultaneously and, as required by users, display the projection, contents from these sources on the same screen or switch between different screens.

In the first aspect of the present invention, a network projection system is provided comprising announcement means for announcing virtual network projection device information over a network and receiving a projection request from at least one network projection source, projection data receiving means for receiving data used in projection from the at least one network projection source, processing means for processing the data received from the at least one network projection source to meet a user's requirement, and projection data displaying means for displaying the processed projection data on a connected display device or transmitting the processed projection data to another network projection device over the network.

Preferably, said projection data receiving means comprises a RDP receiving module for receiving projection data used by a WINDOWS network projection device, and/or a MDP receiving module for receiving projection data used by an IGRS (Intelligent Grouping and Resource Sharing) network projection device.

Preferably, said projection data displaying means comprises a RDP transmitting module for transmitting projection data used by a WINDOWS network projection device, and/or a MDP transmitting module for transmitting projection data used by an IGRS network projection device.

Preferably, said network projection device information contains an announcement message for a RDP network projection device and/or an announcement message for a MDP network projection device.

Preferably, said announcement message for a RDP network projection device includes UPnP device type, connection address, connection port and service interface.

Preferably, said announcement message for a MDP network projection device includes IGRS device type, connection address, connection port, authentication scheme and query interface.

In a further aspect of the present invention, a network projection method is provided comprising steps of announcing network projection device information at a first position on a network and receiving a projection request from at least one network projection source, receiving at the first position data used in projection from the at least one network projection source located at a second position, processing the data received from the at least one network projection source to meet a user's requirement, and displaying the processed projection data directly on a connected display device or transmitting to another network projection device over the network.

Preferably, said receiving comprises steps of receiving projection data used by a WINDOWS network projection device, and/or receiving projection data used by an IGRS network projection device.

Preferably, said transmitting comprises steps of transmitting projection data used by a WINDOWS network projection device, and/or transmitting projection data used by an IGRS network projection device.

Preferably, said network projection device information contains an announcement message for a RDP network projection device and/or an announcement message for a MDP network projection device.

Preferably, said announcement message for a RDP network projection device includes UPnP device type, connection address, connection port and service interface.

Preferably, said announcement message for a MDP network projection device includes IGRS device type, connection address, connection port, authentication scheme and query interface.

With the above structure of the present invention, a common display/projection device can be virtualized as a network projection device to facilitate network access and simultaneous display of projection contents from multiple projection sources on the same screen or switching of display.

### BRIEF DESCRIPTION OF THE DRAWINGS

FIG. 1 is a network environment in which a network projection system according to an embodiment of the present invention is applied;

FIG. 2 shows a block diagram of the network projection system according to an embodiment of the present invention;

FIG. 3 shows a flowchart of the operation of the network projection system as shown in FIG. 1.

### DETAILED DESCRIPTION OF THE PREFERRED EMBODIMENTS

Now, a detailed description will be given to the system and method of an embodiment of the present invention with reference to the figures.

FIG. 1 is a network environment in which a network projection system according to an embodiment of the present invention is applied.

As shown in FIG. 1, a host 10 is connected to a network 600 and comprises a control unit 200, a local display device 300 and a virtual network projection system 100. The control unit 200 receives project data from a remote projection source 400 via the virtual network projection system 100 and, as required by the projection source 400, transmits the projection data to either the local display device 300 or a network projection device 500 again over the network 600 for network display.

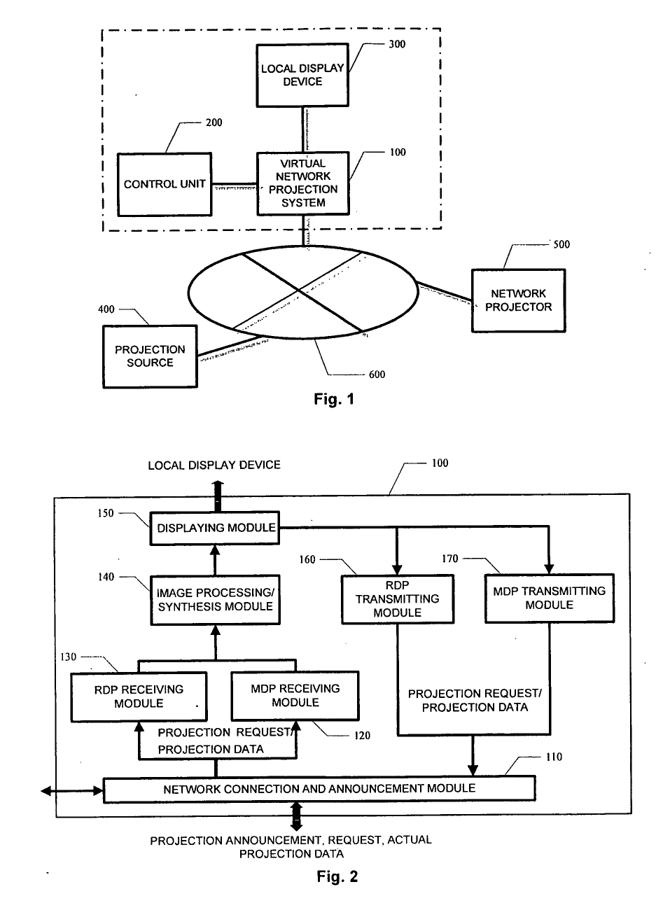

FIG. 2 shows a block diagram of the network projection system according to an embodiment of the present invention. As shown in FIG. 2, the network projection system 100 according to the present embodiment comprises a network connection and announcement module 110, a RDP (Remote Desktop Protocol) receiving module 130, a MDP (Multiple Destination Projection) receiving module 120, an image processing/synthesis module 140, a display module 150, a RDP transmitting module 160 and a MDP transmitting module 170.

The network connection and announcement module 110 provides network connection for the overall system, including announcing network projection device information to the outside, receiving announcement information of a projection device from the outside, receiving an external projection request and projection data, and transmitting the projection request and projection data.

The announcement of network projection device includes an announcement message for a RDP network projection device containing, but not limited to, UPnP device type, connection address, connection port and service interface, and an announcement message for a MDP network projection device containing, but not limited to, IGRS device type (the type is IGRS projection device), connection address, connection port, authentication scheme and query interface.

The RDP receiving module 130 is a network projection device receiving module based on RDP, which maintains a virtual display buffer area during running time and realizes a network projection device receiving module with RDP being the protocol, so that projection information received from the network is stored in a virtual display buffer area maintained by the image processing/synthesis module 140.

The MDP receiving module 120 is a network projection device receiving module based on MDP, which maintains a virtual display buffer area during running time and realizes a network projection device receiving module with IGRS network projection device being the protocol, so that projection information received from the network is stored in another virtual display buffer area maintained by the image processing/synthesis module 140.

The image processing/synthesis module 140 maintains several virtual display buffer areas for projection contents from different projection sources and converts the received display data in the virtual display buffer areas.

The image processing/synthesis module 140 further synthesizes and processes the virtual display information received by the RDP receiving module 130 and the MDP receiving module 120, and then transmits the synthesized information to a synthesis virtual display buffer areas of the display module 150.

The display module 150 maintains several synthesis virtual display buffer areas and, based on a user's input, outputs the information in these synthesis virtual display buffer areas to different devices including a local display device, such as a host main screen, an extended screen and a network projection device (including RDP and IGRS network projection devices).

The RDP transmitting module 160 is a network projection device transmitting module based on RDP, which takes a synthesis virtual display buffer area as input source during running time and realizes a network projection device transmitting module with RDP being the protocol, so that display information stored in the synthesis virtual display buffer area is transmitted to another side on the network via the network connection and announcement module 110.

The MDP transmitting module 170 is a network projection device transmitting module based on MDP, which takes a synthesis virtual display buffer area as input source during running time and realizes a network projection device transmitting module of IGRS network projection device, so that display information stored in the synthesis virtual display buffer area is transmitted to another side on the network via the network connection and announcement module 110.

As shown in FIG. 1, the control unit 200 is connected to the virtual network projection system 100 of the present invention, announces over the network that the display device is a network projection device or an IGRS network projection device by use of the network connection and announcement module 110, and can make an announcement over different networks based on the characteristic of the current host 10 (whether it has more than one sockets).

If the projection source on the network makes a request for projection, the control unit 200, after receiving the projection request, calls a projection receiving client corresponding to the request manner (RDP/MDP) and display on a corresponding display device according to a user's selection/settings.

When there are multiple PC projection sources accessed simultaneously, the control unit 200 provides respective arrangement modes and enables the user to control how to present multiple clients on a screen (including switching, lateral arrangement, vertical arrangement, etc.).

The above network projection device is a WINDOWS or IGRS network projection device.

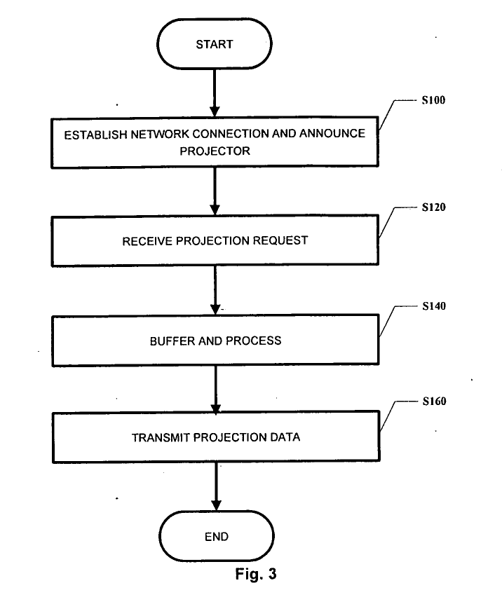

FIG. 3 shows a flowchart of the operation of the network projection system as shown in FIG. 1. As shown in FIG. 3, the control unit 200 controls the network connection and announcement module 110 to establish a connection with the remote projection source 400 and the network projection device 500 and to announce the network projection device information to the outside (S100). Such announcement of network projection device includes an announcement message for a RDP network projection device containing, but not limited to, UPnP device type, connection address, connection port and service interface, and an announcement message for a MDP network projection device containing, but not limited to, IGRS device type (the type is IGRS projection device), connection address, connection port, authentication scheme and query interface.

At this time, if the remote projection source 400 wants a network projection, for example, it needs a projection on the network projection device 500, it transmits a projection request to the host 10, which in turns receives the projection request from the projection source 400 (S120).

Then, depending on the type of the network projection device 500, for example, whether it is a WINDOWS or IGRS network projection device, the RDP receiving module 130 or the MDP receiving module 120 is used to receive respective projection content from the remote projection source 400 and transmit the project content to the buffer area maintained by the image processing/synthesis module 140. The project content is then synthesized in the display module 150 (S140).

Next, depending on the type of the network projection device 500, the RDP transmitting module 160 or the MDP transmitting module 170 is used to transmit via the network connection and announcement module 110 the synthesized projection data to the remote network projection device 500 for projection (S160).

The foregoing description is only intended to illustrate the embodiments of the present invention other than limiting the present invention. For those skilled in the art, any change or substitution that can be made readily within the scope of the present invention should be encompassed by the scope of the present invention. Therefore, the scope of the present invention should be defined by the claims.

What is claimed is:

1. A network projection system comprising:
announcement means for announcing virtual network projection device information over a network and receiving a projection request from at least one network projection source;
projection data receiving means for receiving data used in projection from the at least one network projection source;
processing means for processing the data received from the at least one network projection source to meet a user's requirement; and
projection data displaying means for displaying the processed projection data on a connected display device or transmitting the processed projection data to another network projection device over the network.

2. The network projection system of claim 1, wherein said projection data receiving means comprises:
a RDP receiving module for receiving projection data used by a WINDOWS network projection device; and/or
a MDP receiving module for receiving projection data used by an IGRS network projection device.

3. The network projection system of claim 2, wherein said projection data displaying means comprises:
a RDP transmitting module for transmitting projection data used by a WINDOWS network projection device; and/or
a MDP transmitting module for transmitting projection data used by an IGRS network projection device.

4. The network projection system of claim 1, wherein said network projection device information contains an announcement message for a RDP network projection device and/or an announcement message for a MDP network projection device.

5. The network projection system of claim 4, wherein said announcement message for a RDP network projection device includes UPnP device type, connection address, connection port and service interface.

6. The network projection system of claim 4, wherein said announcement message for a MDP network projection device includes IGRS device type, connection address, connection port, authentication scheme and query interface.

7. A network projection method comprising:
announcing network projection device information at a first position on a network and receiving a projection request from at least one network projection source;
receiving at the first position data used in projection from the at least one network projection source located at a second position;
processing the data received from the at least one network projection source to meet a user's requirement; and
displaying the processed projection data directly on a connected display device or transmitting to another network projection device over the network.

8. The network projection method of claim 7, wherein said receiving comprises steps of:
receiving projection data used by a WINDOWS network projection device; and/or
receiving projection data used by an IGRS network projection device.

9. The network projection method of claim 7, wherein said transmitting comprises steps of:
transmitting projection data used by a WINDOWS network projection device; and/or
transmitting projection data used by an IGRS network projection device.

10. The network projection method of claim 7, wherein said network projection device information contains an announcement message for a RDP network projection device and/or an announcement message for a MDP network projection device.

11. The network projection method of claim 10, wherein said announcement message for a RDP network projection device includes UPnP device type, connection address, connection port and service interface.

12. The network projection method of claim 10, wherein said announcement message for a MDP network projection device includes IGRS device type, connection address, connection port, authentication scheme and query interface.
